(19) United States
(12) Patent Application Publication
(10) Pub. No.: US 2003/0136046 A1
(43) Pub. Date: Jul. 24, 2003

(54) Fuel additive

(76) Inventors: Graham Jackson, Berkshire (GB); Robert D. Tack, Oxfordshire (GB)

Correspondence Address: Infineum USA L.P., Law Department, 1900 East Linden Avenue, P.O. Box 710, Linden, NJ, 07036-0710, US

(21) Appl. No.: 10/284,620

(22) Filed: Oct. 31, 2002

(30) Foreign Application Priority Data
Nov. 21, 2001 (GB) 0127915.7
Dec. 11, 2001 (EP) 01310326.2

(51) Int. Cl. C10L 1/18; C08K 5/01

(52) U.S. Cl. 44/385; 44/393; 44/412; 524/487; 524/275; 524/500

(57) ABSTRACT

A fuel additive comprising a) at least one wax having a refractive index of greater than 1.4550 at 70° C. and a melting point of less than 40° C.; and at least one of the following:

b) at least one growth arrestor;

c) at least one polar nitrogen compound;

d) at least one nucleator;

e) at least one comb polymer; and

f) at least one alkyl phenol formaldehyde condensate.

The fuel additive is effective at reducing low temperature operability of fuel oils having a cloud point of less than or equal to −15° C., preferably less than or equal to −20° C., and even more preferably less than or equal to −25° C.

This invention concerns a fuel additive. In particular, this invention concerns a fuel additive suitable for lowering low temperature operability below the cloud point of a fuel oil.

Fuel additives are known for reducing the low temperature operability of fuel oils. However, known fuel additives are often ineffective in lowering the low temperature operability of fuel oils having a cloud point of less than or equal to −25° C.

Winter diesel fuel oils in Canada and most northern states of the USA have a cloud point between −50° C. and −15° C. Kerosene, which has a cloud point of −50° C., needs to be added to the fuel oils in order to reduce their cloud points. The demand for kerosene for low temperature grades of fuel oils increases markedly during the winter months, putting pressure on the ability of refineries to meet demand.

CFPP (cold filter plugging point test—see J. Inst. Pet. vol. 52 (510), June 1966, pp 173-285) is a test that is widely used in Europe to determine cold flow operability of fuels. In North America this test is replaced by LTFT (low temperature filterability test, ASTM D 4539).

The aim of the present invention is to provide an improved fuel additive for lowering the low temperature operability of fuel oils.

A further aim of the present invention is to provide a cold flow additive for fuel oils having a cloud point of less than or equal to −20° C.

A further aim of the present invention is to provide a fuel additive that can be used to replace, in part or in full, the use of kerosene in fuel oils, preferably diesel fuel oils, having a cloud point of less than or equal to −20° C.

In accordance with the present invention there is provided a fuel additive comprising

a) at least one wax having a refractive index of greater than 1.4550 at 70° C. and a melting point of less than 40° C.; and at least one of the following:

b) at least one growth arrestor;

c) at least one polar nitrogen compound;

d) at least one nucleator;

e) at least one comb polymer; and

f) at least one alkyl phenol formaldehyde condensate.

The fuel additive preferably comprises:

a) at least one wax having a refractive index of greater than 1.4550 at 70° C. and a melting point of less than 40° C.;

b) at least one growth arrestor; and

d) at least one nucleator.

The fuel additive also preferably comprises:

a) at least one wax having a refractive index of greater than 1.4550 at 70° C. and a melting point of less than 40° C.;

c) at least one polar nitrogen compound; and

d) at least one nucleator.

The fuel additive also preferably comprises:

a) at least one wax having a refractive index of greater than 1.4550 at 70° C. and a melting point of less than 40° C.;

b) at least one growth arrestor;

c) at least one polar nitrogen compound; and

d) at least one nucleator.

The fuel additive also preferably comprises:

a) at least one wax having a refractive index of greater than 1.4550 at 70° C. and a melting point of less than 40° C.;

c) optionally at least one polar nitrogen compound;

d) at least one nucleator; and

e) at least one comb polymer.

In accordance with the present invention there is also provided a fuel oil composition comprising the fuel additive defined above and fuel oil.

In accordance with the present invention there is also provided a method for reducing the cloud point of a fuel oil, the method comprising the step of adding the fuel additive defined above to the fuel oil.

Although any fuel oil can be used, the inventors have found that the fuel additive of the present invention is particularly effective in fuel oils having a cloud point of less than or equal to −15° C., preferably less than or equal to −20° C., and even more preferably less than or equal to −25° C.

In accordance with the present invention there is also provided use of the fuel additive defined above as a replacement, in part or in full, for kerosene in fuel oils having a cloud point of less than or equal to −15° C., preferably less than or equal to −20° C., and even more preferably less than or equal to −25° C.

In accordance with the present invention there is also provided a fuel additive concentrate comprising the fuel additive defined above in admixture with a compatible solvent.

a) Wax

Waxes have conventionally been defined by reference to their gross physical characteristics in view of the large and varied number of hydrocarbon components that they contain and the difficulties in separating such closely homologous hydrocarbon molecules. ‘Industrial Waxes’ by H. Bennett published in 1975 describes the different types of petroleum wax and indicates that the characteristics of melting point and refractive index have proved useful in classifying the variety of waxes available from different sources.

The wax needs to have a melting point of less than 40° C. Preferably the wax has a melting point of between 10 and 40° C. More preferably the wax has a melting point of between 15 and 35° C. The melting point is determined using DSC, i.e. differential scanning calorimetry, at heating/cooling rates of 2-5° C. per minute. Further details of the DSC test are provided in the Examples.

The wax needs to have a refractive index of greater than 1.4550 at 70° C. Preferably the wax has a refractive index of greater than 1.4600, more preferably greater than 1.4650. The wax preferably has a refractive index of less than 1.475. The refractive index is determined in accordance with the standard test method ASTM D1747-94, in which the temperature at the point of measurement has been set to 70° C.

The wax is preferably a non-normal paraffinic wax. The term ‘non-normal paraffinic wax’ is used to mean a wax that comprises less than 40% of n-alkanes by weight, based on the total weight of the wax. Preferably the non-normal paraffinic wax contains less than 35%, more preferably less than 30%, and even more preferably less than 20%, of n-alkanes by weight. Most preferably, the non-normal paraffinic wax contains less than 10% of n-alkanes by weight.

The wax is typically obtained by appropriate separation and fractionation of wax-containing distillate fractions, and is available from wax suppliers.

A single wax having the required refractive index and melting point may be used in the fuel additive. A mixture of one or more waxes, at least one of which having the required refractive index and melting point, may also be used.

The wax is preferably present in the fuel oil in an amount ranging from 10 to 10,000 ppm, preferably from 50 to 5,000 ppm and most preferably from 100 to 1,000 ppm.

b) Growth Arrestor

The growth arrestor is also known as a growth inhibitor.

The growth arrestor is preferably a copolymer of ethylene and an unsaturated ester.

A copolymer of ethylene and an unsaturated ester has a polymethylene backbone divided into segments by hydrocarbyl side chains interrupted by one or more oxygen atoms and/or carbonyl groups.

More especially, the copolymer may comprise an ethylene copolymer having, in addition to units derived from ethylene, units of the formula

—CR¹R²—CHR³—

wherein R² represents hydrogen or a methyl group;

R¹ represents a —OOCR⁴ or —COOR⁴ group wherein R⁴ represents hydrogen or a C₁ to C₂₈, preferably a C₁ to C₁₆, more preferably a C₁ to C₉, straight or branched chain alkyl group; and R³ represents hydrogen or a —COOR⁴ or —OOCR⁴ group.

The growth arrestor may comprise a copolymer of ethylene with an ethylenically unsaturated ester, or a derivative thereof. An example is a copolymer of ethylene with an ester of an unsaturated carboxylic acid such as ethylene-acrylate (e.g. ethylene-2-ethylhexylacrylate), but the ester is preferably one of an unsaturated alcohol with a saturated carboxylic acid such as described in GB-A-1,263,152. An ethylene-vinyl ester copolymer is preferably selected from: an ethylene-vinyl acetate, an ethylene vinyl propionate, an ethylene-vinyl hexanoate, an ethylene-vinyl 2-ethylhexanoate, or an ethylene-vinyl octanoate copolymer. Neo acid vinyl esters are also useful. Preferably, the copolymers contain from 1 to 25, preferably 5 to 20 mole % of vinyl ester, more preferably from 5 to 18 mole % of vinyl ester. They may also be in the form of mixtures of two copolymers such as those described in U.S. Pat. No. 3,961,916 and EP-A-113,581. Preferably, number average molecular weight, as measured by vapour phase osmometry, of the copolymer is 1,000 to 10,000, more preferably 1,000 to 5,000. If desired, the copolymers may be derived from additional comonomers, e.g. they may be terpolymers or tetrapolymers or higher polymers, for example where the additional comonomer is isobutylene or diisobutylene or another ester giving rise to different units of the above formula and wherein the above-mentioned mole %'s of ester relate to total ester.

Also, the copolymers may additionally include small proportions of chain transfer agents and/or molecular weight modifiers (e.g. acetaldehyde or propionaldehyde) that may be used in the polymerisation process to make the copolymer.

The copolymers may be made by direct polymerisation of comonomers. Such copolymers may also be made by transesterification, or by hydrolysis and re-esterification, of an ethylene unsaturated ester copolymer to give a different ethylene unsaturated ester copolymer. For example, ethylene-vinyl hexanoate and ethylene-vinyl octanoate copolymers may be made in this way, e.g. from an ethylene vinyl acetate copolymer. Preferred copolymers are ethylene-vinyl acetate or ethylene-vinyl propionate copolymers, or ethylene-vinyl 2-ethylhexanoate or ethylene-vinyl octanoate co- or terpolymers, such as ethylene-vinyl acetate-vinyl 2-ethylhexanoate terpolymers.

The copolymers may, for example, have 15 or fewer, preferably 10 or fewer, more preferably 6 or fewer, most preferably 2 to 5, methyl terminating side branches per 100 methylene groups, as measured by nuclear magnetic resonance spectroscopy, other than methyl groups on a comonomer ester and other than terminal methyl groups.

The copolymers may have a polydispersity of 1 to 6, preferably 2 to 4; polydispersity being the ratio of weight average molecular weight to number average molecular weight both as measured by Gel Permeation Chromatography using polystyrene standards.

The growth arrestor may also be a copolymer of ethylene and 1-alkenes having a carbon chain length of 3 to 8; or a hydrogenated polybutadiene.

The growth arrestor is preferably present in the fuel oil in an amount ranging from 5 to 5,000 ppm, preferably from 10 to 1,000 ppm and most preferably from 20 to 500 ppm.

c) Polar Nitrogen Compound

The polar nitrogen compound is also known as a wax anti-settling additive (‘WASA’).

Polar nitrogen compounds include an oil-soluble polar nitrogen compound carrying one or more, preferably two or more, hydrocarbyl substituted amino or imino substituents, the hydrocarbyl group being monovalent and containing 8 to 40 carbon atoms, and the substituents optionally being in the form of a cation derived therefrom. The oil-soluble polar nitrogen compound is either ionic or non-ionic and is capable of acting as a wax crystal growth modifier in fuel oils. Preferably, the hydrocarbyl group is linear or slightly linear, i.e. it may have one short length (1-4 carbon atoms) hydrocarbyl branch. When the substituent is amino, it may carry more than one said hydrocarbyl group, which may be the same or different.

The term “hydrocarbyl” refers to a group having a carbon atom directly attached to the rest of the molecule and having a hydrocarbon or predominantly hydrocarbon character. Examples include hydrocarbon groups, including aliphatic (e.g. alkyl or alkenyl), alicyclic (e.g. cycloalkyl or cycloalkenyl), aromatic, alicyclic-substituted aromatic, aromatic-substituted aliphatic and alicyclic groups. Aliphatic groups are advantageously saturated. These groups may contain non-hydrocarbon substituents provided their presence does not alter the predominantly hydrocarbon character of the group. Examples include keto, halo, hydroxy, nitro, cyano, alkoxy and acyl. If the hydrocarbyl group is substituted, a single (mono) substituent is preferred.

Examples of substituted hydrocarbyl groups include 2-hydroxyethyl, 3-hydroxypropyl, 4-hydroxybutyl, 2-ketopropyl, ethoxyethyl, and propoxypropyl. The groups may also or alternatively contain atoms other than carbon in a chain or ring otherwise composed of carbon atoms. Suitable hetero atoms include, for example, nitrogen, sulphur, and, preferably, oxygen.

More especially, the or each amino or imino substituent is bonded to a moiety via an intermediate linking group such as —CO—, —CO₂⁽⁻⁾, —SO₃⁽⁻⁾ or hydrocarbylene. Where the linking group is anionic, the substituent is part of a cationic group, as in an amine salt group.

When the polar nitrogen compound carries more than one amino or imino substituent, the linking groups for each substituent may be the same or different.

Suitable amino substituents are long chain C₁₂-C₄₀, preferably C₁₂-C₂₄, alkyl primary, secondary, tertiary or quaternary amino substituents.

Preferably, the amino substituent is a dialkylamino substituent, which, as indicated above, may be in the form of an amine salt thereof; tertiary and quaternary amines can form only amine salts. Said alkyl groups may be the same or different.

Preferably the amino substituents include dodecylamino, tetradecylamino, cocoamino, and hydrogenated tallow amino. Examples of secondary amino substituents include dioctadecylamino and methylbehenylamino. Mixtures of amino substituents may be present such as those derived from naturally occurring amines. A preferred amino substituent is the secondary hydrogenated tallow amino substituent, the alkyl groups of which are derived from hydrogenated tallow fat and are typically composed of approximately 4% C₁₄, 31% C₁₆ and 59% C₁₈ n-alkyl groups by weight.

Suitable imino substituents are long chain C₁₂-C₄₀, preferably C₁₂-C₂₄, alkyl substituents.

The moiety may be monomeric (cyclic or non-cyclic) or polymeric. When non-cyclic, it may be obtained from a cyclic precursor such as an anhydride or a spirobislactone.

The cyclic ring system may include homocyclic, heterocyclic, or fused polycyclic assemblies, or a system where two or more such cyclic assemblies are joined to one another and in which the cyclic assemblies may be the same or different. Where there are two or more such cyclic assemblies, the substituents may be on the same or different assemblies, preferably on the same assembly. Preferably, the or each cyclic assembly is aromatic, more preferably a benzene ring. Most preferably, the cyclic ring system is a single benzene ring when it is preferred that the substituents are in the ortho or meta positions, which benzene ring may be optionally further substituted.

The ring atoms in the cyclic assembly or assemblies are preferably carbon atoms but may for example include one or more ring N, S or O atom, in which case or cases the compound is a heterocyclic compound.

Examples of such polycyclic assemblies include polycyclic aromatics, rings joined “end-on” such as diphenyl, heterocylics or alicyclics.

Examples of polar nitrogen compounds are described below:

(i) an amine salt and/or amide of a mono- or poly-carboxylic acid, e.g. having 1 to 4 carboxylic acid groups. It may be made, for example, by reacting at least one molar proportion of a hydrocarbyl substituted amine with a molar proportion of the acid or its anhydride.

When an amide is formed, the linking group is —CO—, and when an amine salt is formed, the linking group is —CO₂⁽⁻⁾.

The moiety may be cyclic or non-cyclic. Examples of cyclic moieties are those where the acid is cyclohexane 1,2-dicarboxylic acid; cyclohexane 1,2-dicarboxylic acid; cyclopentane 1,2-dicarboxylic acid; and naphthalene dicarboxylic acid. Generally, such acids have 5 to 13 carbon atoms in the cyclic moiety. Preferred such cyclic acids are benzene dicarboxylic acids such as phthalic acid, isophthalic acid, and terephthalic acid, and benzene tetracarboxylic acids such as pyromelletic acid, phthalic acid being particularly preferred. U.S. Pat. No. 4,211,534 and EP-A-272,889 describes polar nitrogen compounds containing such moieties.

Examples of non-cyclic moieties are those when the acid is a long chain alkyl or alkylene substituted dicarboxylic acid such as a succinic acid, as described in U.S. Pat. No. 4,147,520 for example.

Other examples of non-cyclic moieties are those where the acid is a nitrogen-containing acid such as ethylene diamine tetracetic acid and nitrilotriacetic acid.

Further examples are the moieties obtained where a dialkyl spirobislactone is reacted with an amine as described in DE-A-392699.

(ii) A compound having the formula I, or a salt thereof:

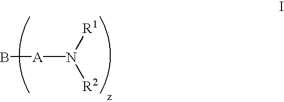

wherein B represents an aromatic system, A represents a hydrocarbyl group, R¹ and R² are the same or are different and each independently is an aliphatic hydrocarbyl group containing 10-40 carbon atoms provided that one of R¹ and R² may represent a hydrogen atom, z is at least 1 and wherein the aromatic system carries at least one substituent group which is an activating group for the ring system or a derivative of an activating group.

By the term hydrocarbyl in this specification is meant an organic moiety that is composed of hydrogen and carbon, which is bonded to the rest of the molecule by a carbon atom or atoms and which, unless the context states otherwise, may be aliphatic, including alicyclic, aromatic or a combination thereof. It may be substituted or unsubstituted, alkyl, aryl or alkaryl and may optionally contain unsaturation or heteroatoms such as O, N or S, provided that such heteroatoms are insufficient to alter the essentially hydrocarbyl nature of the group. It is preferred that A is an aliphatic hydrocarbyl group and more preferably that A is a methylene group.

The term aromatic system is meant to include aromatic homocyclic, heterocyclic or fused polycyclic assemblies, or a system where two or more such cyclic assemblies are joined to one another and in which the cyclic assemblies may be the same or different. Where there are two or more cyclic assemblies and Z is 2 or more the —(A—NR¹R²) groups present may be in the same or different assemblies. It is preferred that the aromatic system is a ring system based on benzene rings.

The ring atoms in the aromatic system are preferably carbon atoms but may, for example, include one or more heteroatoms such as N, S, or O in the system in which case the compound is a heterocyclic compound.

Examples of such polycyclic assemblies include

(a) condensed benzene structures such as naphthalene, anthracene, phenanthrene, and pyrene;

(b) condensed ring structures where none of or not all of the rings are benzene such as azulene, indene, hydroindene, fluorene, and diphenylene;

(c) rings joined “end-on” such as diphenyl;

(d) heterocyclic compounds such as quinoline, indole, 2:3 dihydroindole, benzofuran, coumarin, isocoumarin, benzothiophen, carbazole and thiodiphenylamine; and

(e) bisaromatic systems wherein the rings are linked by one or more divalent groups such as for example bisphenol A or fluorescein.

By the term activating group is meant any group, other than a substituent aliphatic hydrocarbyl group which activates the aromatic system to substitution reactions such as electrophilic substitution, nucleophilic substitution or to the Mannich reaction. The activating group may be a non-substituent group such as functionality that is within the aromatic system as in, for example, heterocyclic compounds such as indole. The activating group is located at least within or on each of the rings of the aromatic system which are substituted with an —(A—NR¹R²) group. It is preferred that the activating group is a group that is on the ring system as opposed to being within the aromatic system. Desirably the activating group or groups activate the aromatic system to electrophilic substitution or to the Mannich reaction, most preferably to the Mannich reaction. It is preferred that the activating group activates the aromatic system in the ortho or para position relative to itself. The preferred activating group is a hydroxyl group. The preferred activated aromatic system is a hydroxy aromatic system. By the term derivative of an activating group is meant any group that can be produced by the reaction of the activating group. For example, when the activating group is a hydroxyl group one derivative would be an —O—C(O)—CH₃ group produced by reaction of the hydroxyl group with, for example, acetic anhydride. There may be more than one activating group or a derivative of an activating group on or in the aromatic system; they may be in or on the same or different rings. There may also be other substituents present that are in or on the aromatic system and are not activating groups or derivatives of activating groups.

Each aliphatic hydrocarbyl group constituting R¹ and R² in the invention may, for example, be an alkyl or alkylene group or a mono or polyalkoxyalkyl group or aliphatic hydrocarbyl group that contains heteroatoms such as O, N or S. Preferably each aliphatic hydrocarbyl group is a straight chain alkyl group. The number of carbon atoms in each aliphatic hydrocarbyl group is preferably 12-24, most preferably 16 to 22.

Preferably, such as when z=1, the aromatic system also carries a substituent of general formula II

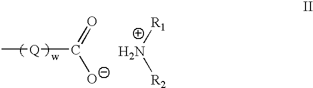

wherein W=0 or 1; Q represents A; and R¹ and R² have the meaning as given above. It is preferred that W=0 and that there is only one additional substituent of the above general formula II. The additional substituent of general formula II may also be present in the aromatic system when z is 2 or more. When there is no additional substituent of general formula II present in the ring system it is preferred that z is 2 or more.

The most preferred compounds of general formula I are those which may be represented by general formula III

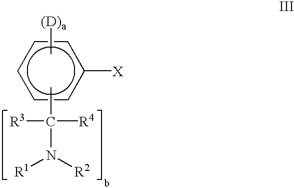

wherein X represents hydrogen, or a hydrocarbyl group, or a non-hydrocarbyl group, or a group of general formula IV:

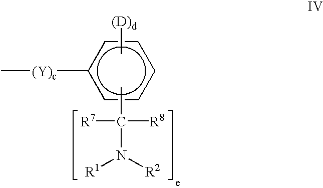

wherein Y is a divalent group and wherein a=1, 2, 3, 4 or 5, b=1, 2, 3 or 4, c=0, 1 or 2, d=0, 1, 2, 3 or 4 and e=0, 1, 2, 3 or 4 and wherein R³ R⁴, R⁷ and R⁸ are hydrogen or hydrocarbyl, and wherein R¹ and R² are independently C₁₀-C₄₀ aliphatic hydrocarbyl groups. D represents a hydroxyl group or a derivative of a hydroxyl group. When D is a derivative of a hydroxyl group it is preferably a —O—C(O)—CH₃ group. The C₁₀-C₄₀ aliphatic hydrocarbyl groups may be linear or branched chains. It is preferred that the chains are linear.

When X is a group other than a group of formula IV preferably a=1 or 2 and b=1, 2, 3 or 4, most preferably a=1 or 2 and b=1, 2 or 3.

When X is a group of formula IV and c=0, preferably a=1, 2 or 3, b=1, 2 or 3, d=0, 1, 2 or 3, and e=0, 1, 2 or 3, most preferably a=1, b=1, d=1 and e=1.

When X is a group of formula IV and c=1, preferably a=1, 2 or 3, b=1, 2 or 3, d=0, 1, 2 or 3 and e=0, 1, 2 or 3, most preferably a=1 or 2, b=1 or 2, d=0, 1 or 2 and e=0, 1 or 2.

In both formulas III and IV the benzene ring may be part of a larger ring system such as a fused polycyclic ring system or may be a heterocyclic ring or an aromatic ring other than benzene.

When c=1 groups III and IV may also be joined directly, as in when c=0, in addition to being joined by the divalent group Y. When c=2 the divalent groups Y may be the same or different.

Preferably R³, R⁴, R⁷ and R⁸ are hydrogen. The aliphatic hydrocarbyl groups R¹ and R² may be the same or different and are preferably independently C₁₀-C₄₀ alkyl groups. Desirably the alkyl groups are independently C₁₂-C₂₄ alkyl groups and most preferably C₁₆-C₂₂ alkyl groups. When there is more than one R¹ or R² group present they may be the same or different aliphatic hydrocarbyl groups. Preferred combinations of alkyl groups are those wherein R¹/R² are either C₁₆/C₁₈, C₂₀/C₂₂, C₁₈/C₁₈ or C₂₂/C₂₂.

The aliphatic hydrocarbyl groups may also contain hetero atoms such as O, N or S. It is preferred that no hetero atoms are present in the aliphatic hydrocarbyl groups and that the groups are linear or those which have low levels of branching.

The divalent group Y may be a substituted or unsubstituted aliphatic group such as for example methylene, —C(CH₃)₂—, —CH(Ph)—, a group of formula V or similar groups,

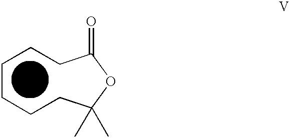

or groups such as —C(O)—, S(O)—, S(O)₂—, —O—, —S—, —C(O)—O— and —C(O)—O—R¹¹—O—C(O)— wherein R₁₁ is a hydrocarbyl group as hereinbefore defined. When there are two divalent groups present i.e. when c=2 they may be the same or different e.g. the combination of the group of formula V and —O— as in fluorescein. The divalent group Y may also be an aromatic group. The divalent group Y may also contain activated cyclic rings which have the substituent group —(A—NR¹R²) present in the cyclic ring.

The compounds of general formula III may also be substituted with one or more groups of general formula II. It is preferred that when X is a group other than that of formula IV and when b=1 that at least one group of general formula II is present in the compound of formula III. The compounds of general formula III may also be substituted with non-hydrocarbyl groups such as for example NO₂ or CN groups.

In the compound of formula I as defined above the activating group is preferably a hydroxyl group. The hydroxyl-aromatic system is hereinafter referred to as an activated compound. The compound is prepared by reacting under Mannich condensation conditions a formaldehyde or an aldehyde and a secondary amine which comprises independently C₁₀-C₄₀ aliphatic hydrocarbyl groups.

The reactants may be used in equimolar or substantially equimolar proportions. The mole ratio of the activated compound to secondary amine may be less than equimolar for example 1:2, 1:3 or 1:4 or more. It is preferred that the mole ratio of activated compound to secondary amine is 1:2 or substantially 1:2 and that there is sufficient formaldehyde present to enable this mole ratio to be achieved in the final product.

The reaction may be carried out in a solvent for example toluene or without a solvent and at a temperature in the range of 80° C. to 120° C.

The aldehyde may be any aldehyde that reacts with an activated compound and a C₁₀-C₄₀ aliphatic hydrocarbyl secondary amine under Mannich condensation conditions. It is preferred that formaldehyde is used in the method. The formaldehyde may be employed in any of its conventional forms; it may be used in the form of an aqueous solution such as formalin, as paraformaldehyde or as trioxane.

Suitable hydroxyaromatic compounds include for example: substituted phenols such as 2-, 3-, or 4-hydroxybenzophenone, 2-, 3-, or 4-hydroxybenzoic acid and 1 or 2-naphthol; dihydroxy compounds such as resorcinol, catechol, hydroquinone, 2,2′- biphenol, 4,4′biphenol, fluorescein, 2,2-bis(p-hydroxy phenyl)propane, dihydroxybenzophenones, 4,4′-thiodiphenol, or dihydroxy benzoic acids such as 2,4-, or 3,5-dihydroxybenzoic acid; or trisphenolic compounds such as 1,1,1-tris-(4-hydroxy phenyl)ethane. The hydroxy aromatic compounds may be substituted, for example, with one or more of the following substituents: no-hydrocarbyl groups such as —NO₂ or CN; or hydrocarbyl groups such as —CHO, —COOR, —COR, —COOR; or aliphatic hydrocarbyl groups such as alkyl groups. The substituent or substituents may be in the ortho, para or meta or any combination of these positions in relation to the hydroxyl group or groups. When the hydroxyaromatic compound is a substituted phenol it is preferred that the substitution is in the ortho or para position. Phenols which have certain para substituents have been found to produce bisdialkylaminomethyl Mannich reaction products, derived from secondary amines with aliphatic hydrocarbyl groups of C₁₀ to C₄₀, under milder reaction conditions and with greater ease than when using unsubstituted phenol. In some cases substitution in the ortho position also allows easier reaction under milder conditions, though some such substituents are not beneficial, such as those substituents which are able to hydrogen bond with the hydroxyl group. A suitable ortho substituent is a cyano group. It will be understood that with dihydroxy compounds such as catechol where two or more hydroxy groups are present in the same ring, that any one substituent may be ortho with respect to one of these hydroxy groups and meta in relation to the other.

The amine may be any secondary amine that contains linear and/or branched chain aliphatic hydrocarbyl groups of C₁₀-C₄₀, and preferably C₁₂-C₂₄ and most preferably C₁₆-C₂₂. Preferred secondary amines are linear or those that have low levels of branching.

Examples of suitable secondary amines include the simple secondary amines such as N,N-dihexadecylamine, N,N-dioctadecylamine, N,N-dieicosylamine, N,N-didocosylamine, N,N-dicetylamine, N,N-distearylamine, N,N-diarachidylamine, N,N-dibehenylamine, N,N-di hydrogenated tallow amine and mixed secondary amines which comprise a mixture of any two of the following functionality: hexadecyl, octadecyl, eicosyl, docosyl, cetyl, stearyl, arachidyl, behenyl or hydrogenated tallow or that derived from the fatty acids of coconut oil.

Additional substituents of general formula II may be formed on the aromatic system during the above reaction by reacting activated compounds which have a carboxylic acid group present, with the corresponding amount of amine to take part in the above reaction and also to neutralise the carboxylic acid groups present. Alternatively the carboxylic acid groups may be neutralised after the reaction by adding the required amount of amine, which may be the same or a different amine to that used in the reaction, to neutralise the carboxylic acid groups.

There may be an additional reaction stage to convert the activating group into a derivative of the activating group such as, for example, the conversion of a hydroxyl group to its acetate ester by reaction for example with acetic anhydride.

(iii) A condensate of a long chain primary or secondary amine with a carboxylic acid-containing polymer.

Specific examples include polymers such as described in GB-A-2,121,807, FR-A-2,592,387 and DE-A-3,941,561; and also esters of telomer acid and alkanoloamines such as described in U.S. Pat. No. 4,639,256; and the reaction product of an amine containing a branched carboxylic acid ester, an epoxide and a mono-carboxylic acid polyester such as described in U.S. Pat. No. 4,631,071.

EP 0,283,292 describes amide containing polymers and EP 0,343,981 describes amine-salt containing polymers.

It should be noted that the polar nitrogen compounds may contain other functionality such as ester functionality.

The polar nitrogen compound is preferably present in the fuel oil in an amount ranging from 5 to 5,000 ppm, preferably from 10 to 1,000 ppm and most preferably from 20 to 500 ppm.

d) Nucleator

The nucleator is preferably a polyoxyalkylene compound. Examples include polyoxyalkylene esters, ethers, ester/ethers and mixtures thereof, particularly those containing at least one, preferably at least two, C₁₀ to C₃₀ linear alkyl groups and one or more polyoxyalkylene glycol group of molecular weight up to 5,000, preferably 200 to 5,000, the alkylene group in said polyoxyalkylene glycol containing from 1 to 4 carbon atoms, as described in EP-A-61 895 and in U.S. Pat. No. 4,491,455.

Preferred glycols are substantially linear polyethylene glycols (PEG) and polypropylene glycols (PPG) having a molecular weight of about 100 to 5,000, preferably about 200 to 2,000. Esters are also preferred and fatty acids containing from 10 to 30 carbon atoms are useful for reacting with the glycols to form the ester additives, it being preferred to use C₁₈ to C₂₄ fatty acid, especially stearic and behenic acids. The esters may also be prepared by esterifying polyethoxylated fatty acids, polyethoxylated alcohols or polyols. Polyoxyalkylene diesters, diethers, ether/esters and mixtures thereof are suitable as additives, when minor amounts of monoethers and monoesters (which are often formed in the manufacturing process) may also be present. In particular, stearic or behenic diesters of polyethylene glycol, polypropylene glycol or polyethylene/polypropylene glycol mixtures are preferred.

Examples of other compounds in this general category are those described in Japanese Patent Publication Nos. 2-51477 and 3-34790, and EP-A-117,108 and EP-A-326,356, and cyclic esterified ethoxylates such as described EP-A-356,256.

Other suitable esters are those obtainable by the reaction of:

(i) an aliphatic monocarboxylic acid having 10 to 40 carbon atoms, and

(ii) an alkoxylated aliphatic monohydric alcohol, in which the alcohol has greater than 18 carbon atoms prior to alkoxylation and in which the degree of alkoxylation is 5 to 30 moles of alkylene oxide per mole of alcohol.

The ester may be formed from a single acid reactant (i) and single alcohol reactant (ii), or from mixtures of acids (i) or alcohols (ii) or both. In the latter cases, a mixture of ester products will be formed which may be used without separation if desired, or separated to give discrete products before use.

These materials may also be prepared by alkoxylation of a fatty acid ester of a polyol (e.g. ethoxylated sorbitan tristearate having the trade name TWEEN 65, which is available from Uniqema, owned by ICI).

The degree of alkoxylation of the aliphatic monohydric alcohol is preferably 10 to 25 moles of alkylene oxide per mole of alcohol, more preferably 15 to 25 moles. The alkoxylation is preferably ethoxylation, although propoxylation or butoxylation can also be used successfully. Mixed alkoxylation, for example a mixture of ethylene and propylene oxide units, may also be used.

The acid reactant (i) preferably has 18 to 30 carbon atoms, more preferably 16 to 24 carbon atoms such as 18 or 22 carbon atoms. The acid is preferably a saturated aliphatic acid, more preferably an alkanoic acid. Alkanoic acids of 16 to 30 carbon atoms are particularly useful. n-Alkanoic acids are preferred. Such acids include behenic acid and arachidic acid, with behenic acid being preferred. Where mixtures of acids are used, it is preferred that the average number of carbon atoms in the acid mixture lies in the above-specified ranges and preferably the individual acids within the mixture will not differ by more than 8 (and more preferably 4) carbon numbers.

The alcohol reactant (ii) is preferably derived from an aliphatic monohydric alcohol having no more than 28 carbon atoms, and more preferably no more than 26 (or better, 24) carbon atoms, prior to alkoxylation. The range of 18 to 22 is particularly advantageous for obtaining good wax crystal modification. The aliphatic alcohol is preferably a saturated aliphatic alcohol, especially an alkanol (i.e. alkyl alcohol). Alkanols having 16 to 28 carbon atoms, and particularly 18 to 26, such as 18 to 22 carbon atoms are preferred. n-Alkanols are most preferred, particularly those having 16 to 24 carbon atoms, and preferably 18 to 22 carbon atoms.

Where the alcohol reactant (ii) is a mixture of alcohols, this mixture may comprise a single aliphatic alcohol alkoxylated to varying degrees, or a mixture of aliphatic alcohols alkoxylated to either the same or varying degrees. Where a mixture of aliphatic alcohols is used, the average carbon number prior to alkoxylation should be above 16 and preferably within the preferred ranges recited above. Preferably, the individual alcohols in the mixture should not differ by more than 4 carbon atoms.

The esterification can be conducted by normal techniques known in the art. Thus, for example, one mole equivalent of the alkoxylated alcohol is esterified by one mole equivalent of acid by azeotroping in toluene at 110-120° C. in the presence of 1 weight percent of p-toluene sulphonic acid catalyst until esterification is complete, as judged by Infra-Red Spectroscopy and/or reduction of the hydroxyl and acid numbers.

The alkoxylation of the aliphatic alcohol is also conducted by well-known techniques. Thus, for example, a suitable alcohol is (where necessary) melted at about 70° C. and 1 wt % of potassium ethoxide in ethanol added, the mixture thereafter being stirred and heated to 100° C. under a nitrogen sparge until ethanol ceases to be distilled off, the mixture subsequently being heated to 150° C. to complete formation of the potassium salt. The reactor is then pressurised with alkylene oxide until the mass increases by the desired weight of alkylene oxide (calculated from the desired degree of alkoxylation). The product is finally cooled to 90° C. and the potassium neutralised (e.g. by adding an equivalent of lactic acid).

Compounds wherein the acid (i) is an alkanoic acid and the alkoxylated alcohol (ii) is formed from one mole of a C₁₈ to C₂₂ alkanol and 15 to 25 moles of ethylene oxide have been found to be particularly effective as low temperature flow and filterability improvers, giving excellent wax crystal modification. In such embodiments, the acid (i) is preferably an n-alkanoic acid having 18 to 22 carbon atoms and the alkanol preferably has 16 to 22, more preferably 18 to 22 carbon atoms. Such a combination of structural features has been found to be particularly advantageous in providing improved wax crystal modification.

The nucleator is preferably present in the fuel oil in an amount ranging from 5 to 1,000 ppm, preferably from 10 to 500 ppm and most preferably from 10 to 200 ppm.

e) Comb Polymers

Comb polymers are discussed in “Comb-Like Polymers. Structure and Properties”, N. A. Platé and V. P. Shibaev, J. Poly. Sci. Macromolecular Revs., 8, p 117 to 253 (1974).

Generally, comb polymers consist of molecules in which long chain branches such as hydrocarbyl branches, optionally interrupted with one or more oxygen atoms and/or carbonyl groups, having from 6 to 30 such as 10 to 30, carbon atoms, are pendant from a polymer backbone, said branches being bonded directly or indirectly to the backbone. Examples of indirect bonding include bonding via interposed atoms or groups, which bonding can include covalent and/or electrovalent bonding such as in a salt. Generally, comb polymers are distinguished by having a minimum molar proportion of units containing such long chain branches.

Advantageously, the comb polymer is a homopolymer or a copolymer having at least 25 and preferably at least 40, more preferably at least 50, molar per cent of units having side chains containing at least 6, such as at least 8, and preferably at least 10, atoms, selected from, for example, carbon, nitrogen and oxygen, in a linear chain or a chain containing a small amount of branching such as a single methyl branch.

As examples of preferred comb polymers there may be mentioned those containing units of the general formula

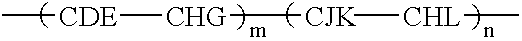

where D represents R¹¹, COOR¹⁰, OCOR¹⁰, R¹¹COOR¹⁰ or OR¹⁰;

E represents H, D or R¹¹;

G represents H or D;

J represents H, R¹¹, R¹¹COOR¹⁰, or a substituted or unsubstituted aryl or heterocyclic group;

K represents H, COOR¹¹, OCOR¹¹, OR¹¹ or COOH;

L represents H, R¹¹, COOR¹¹, OCOR¹¹ or substituted or unsubstituted aryl;

R¹⁰ representing a hydrocarbyl group having 10 or more carbon atoms, and

R¹¹ representing a hydrocarbylene (divalent) group in the ¹¹COOR¹⁰ moiety and otherwise a hydrocarbyl (monovalent) group,

and m and n represent mole ratios, their sum being 1 and m being finite and being up to and including 1 and n being from zero to less than 1, preferably m being within the range of from 1.0 to 0.4 and n being in the range of from 0 to 0.6. R¹⁰ advantageously represents a hydrocarbyl group with from 10 to 30 carbon atoms, preferably 10 to 24, more preferably 10 to 18. Preferably, R¹⁰ is a linear or slightly branched alkyl group and R¹¹ advantageously represents a hydrocarbyl group with from 1 to 30 carbon atoms when monovalent, preferably with 6 or greater, more preferably 10 or greater, preferably up to 24, more preferably up to 18 carbon atoms. Preferably, R¹¹, when monovalent, is a linear or slightly branched alkyl group. When R¹¹ is divalent, it is preferably a methylene or ethylene group. By “slightly branched” is meant having a single methyl branch.

The comb polymer may contain units derived from other monomers if desired or required, examples being CO, vinyl acetate and ethylene. It is within the scope of the invention to include two or more different comb copolymers.

The comb polymers may, for example, be copolymers of maleic anhydride or fumaric acid and another ethylenically unsaturated monomer, e.g. an α-olefin or an unsaturated ester, for example, vinyl acetate as described in EP-A-214,786. It is preferred but not essential that equimolar amounts of the comonomers be used although molar proportions in the range of 2 to 1 and 1 to 2 are suitable. Examples of olefins that may be copolymerized with e.g. maleic anhydride, include 1-decene, 1-dodecene, 1-tetradecene, 1-hexadecene, 1-octadecene, and styrene. Other examples of comb polymers include methacrylates and acrylates.

The copolymer may be esterified by any suitable technique and although preferred it is not essential that the maleic anhydride or fumaric acid be at least 50% esterified. Examples of alcohols that may be used include n-decan- 1-ol, n-dodecan-1-ol, n-tetradecan-1-ol, n-hexadecan-1-ol, and n-octadecan-1-ol. The alcohols may also include up to one methyl branch per chain, for example, 1-methylpentadecan-1-ol, 2-methyltridecan-1-ol as described in EP-A-213,879. The alcohol may be a mixture of normal and single methyl branched alcohols. It is preferred to use pure alcohols rather than alcohol mixtures such as may be commercially available; if mixtures are used, the number of carbon atoms in the alkyl group is taken to be the average number of carbon atoms in the alkyl groups of the alcohol mixture; if alcohols that contain a branch at the 1 or 2 positions are used, the number of carbon atoms in the alkyl group is taken to be the number in the straight chain backbone segment of the alkyl group of the alcohol.

The copolymer may also be reacted with a primary and/or secondary amine, for example, a mono- or di-hydrogenated tallow amine.

The comb polymers may especially be fumarate or itaconate polymers and copolymers such as for example those described in European Patent Applications 153 176, 153 177, 156 577 and 225 688, and WO 91/16407.

Particularly preferred fumarate comb polymers are copolymers of alkyl fumarates and vinyl acetate, in which the alkyl groups have from 12 to 20 carbon atoms, more especially polymers in which the alkyl groups have 14 carbon atoms or in which the alkyl groups are a mixture of C₁₂/C₁₄ alkyl groups, made, for example, by solution copolymerizing an equimolar mixture of fumaric acid and vinyl acetate and reacting the resulting copolymer with the alcohol or mixture of alcohols, which are preferably straight chain alcohols. When the mixture is used it is advantageously a 1:1 by weight mixture of normal C₁₂ and C₁₄ alcohols. Furthermore, mixtures of the C₁₂ ester with the mixed C₁₂/C₁₄ ester may advantageously be used. In such mixtures, the ratio of C₁₂ to C₁₂/C₁₄ is advantageously in the range of from 1:1 to 4:1, preferably 2:1 to 7:2, and most preferably about 3:1, by weight. The particularly preferred fumarate comb polymers may, for example, have a number average molecular weight in the range of 1,000 to 100,000, preferably 1,000 to 50,000, as measured by Vapour Phase Osmometry (VPO).

Other suitable comb polymers are the polymers and copolymers of α-olefins and esterified copolymers of styrene and maleic anhydride, and esterified copolymers of styrene and fumaric acid as described in EP-A-282,342; mixtures of two or more comb polymers may be used in accordance with the invention and, as indicated above, such use may be advantageous.

Other examples of comb polymers are hydrocarbon polymers such as copolymers of ethylene and at least one α-olefin, preferably the α-olefin having at most 20 carbon atoms, examples being n-octene-1, iso octene-1, n-decene-1 and n-dodecene-1, n-tetradecene-1 and n-hexadecene-1 (for example, as described in WO 93/19106). Preferably, the number average molecular weight measured by Gel Permeation Chromatography against polystyrene standards of such a copolymer is, for example, up to 30,000 or up to 40,000. The hydrocarbon copolymers may be prepared by methods known in the art, for example using a Ziegler type catalyst. Such hydrocarbon polymers may for example have an isotacticity of 75% or greater.

The comb polymer may be present in the fuel oil in an amount ranging from 5 to 5,000 ppm, preferably from 10 to 1,000 ppm and most preferably from 20 to 500 ppm.

f) Alkyl Phenol Formaldehyde Condensates

Suitable alkyl phenol formaldehyde condensates are disclosed in EP 0 311 452 and EP 0 851 776.

The alkyl phenol formaldehyde condensate may be obtainable by the condensation reaction between:

(i) at least one aldehyde or ketone or reactive equivalent thereof, and

(ii) at least one compound comprising one or more aromatic moieties bearing at least one substituent of the formula —XR¹ and at least one further substituent —R², wherein:

X represents oxygen or sulphur,

R¹ represents hydrogen or a moiety bearing at least one hydrocarbyl group, and

R² represents a hydrocabyl group, linear or branched, preferably containing from 4 to 40 carbons atoms, more preferably containing from 8 to 30 carbon atoms and most preferably containing from 8 to 18 carbon atoms.

The alkyl phenol formaldehyde condensate may be present in the fuel oil in an amount ranging from 5 to 5,000 ppm, preferably 10 to 1,000 ppm and most preferably from 20 to 500 ppm.

Co-Additives

In addition, the fuel additive may comprise one or more other conventional co-additives known in the art, such as: detergents, antioxidants, corrosion inhibitors, de-hazers, demulsifiers, metal deactivators, antifoaming agents, cetane improvers, co-solvents, package compatibilizers, lubricity additives and antistatic additives.

Fuel Oil Composition

The fuel oil may be a hydrocarbon fuel oil such as a petroleum-based fuel oil, for example kerosene or distillate fuel oil, or a middle distillate fuel oil, i.e. a fuel oil obtained in refining crude oil as the fraction between the lighter kerosene and jet fuels fraction and the heavier fuel oil fraction. Such distillate fuel oils generally boil within the range of about 100° C. to about 500° C., such as 150° C. to about 400° C., for example, those having a relatively high final boiling point of above 360° C. ASTM-D86 Middle distillates contain a spread of hydrocarbons boiling over a temperature range. They are also characterised by pour point, cloud point and CFPP, as well as their initial boiling point (IBP) and final boiling point (FBP). The fuel oil can comprise atmospheric distillate or vacuum distillate, or cracked gas oil or a blend in any proportion of straight run and thermally and/or catalytically cracked distillates. The most common petroleum distillate fuels are kerosene, jet fuels, diesel fuels, heating oils and heavy fuel oils, diesel fuels and heating oils being preferred. The diesel fuel or heating oil may be a straight atmospheric distillate, or may contain minor amounts, e.g. up to 35 wt %, of vacuum gas oil or cracked gas oils or both.

Heating oils may be made of a blend of virgin distillate, e.g. gas oil, naphtha, etc. and cracked distillates, e.g. catalytic cycle stock. A representative specification for a diesel fuel includes a minimum flash point of 38° C. and a 90% distillation point between 282 and 380° C. (see ASTM Designations D-396 and D-975).

Also, the fuel oil may be an animal or vegetable oil (i.e. a ‘biofuel’), or a mineral oil as described above in combination with one or more animal or vegetable oils.

Examples of oils are rapeseed oil, coriander oil, soyabean oil, cottonseed oil, sunflower oil, castor oil, olive oil, peanut oil, maize oil, almond oil, palm kernel oil, coconut oil, mustard seed oil, beef tallow and fish oils. Rapeseed oil, which is a mixture of fatty acids esterified with glycerol, is preferred as it is available in large quantities and can be obtained in a simple way by pressing from rapeseed.

Examples of derivatives thereof are alkyl esters, such as methyl esters, of fatty acids of the vegetable or animal oils. Such esters can be made by transesterification.

As lower alkyl esters of fatty acids, consideration may be given to the following, for example, as commercial mixtures: the ethyl, propyl, butyl and especially methyl esters of fatty acids with 12 to 22 carbon atoms, for example, of lauric acid, palmitic acid, stearic acid, oleic acid, ricinoleic acid and linoleic acid.

The inventors have found that the fuel additive is particularly effective as a cold flow improver in fuel oils, preferably diesel fuel oils, having a cloud point of less than or equal to −15° C., preferably less than or equal to −20° C., and even more preferably less than or equal to −25° C.

The fuel additive is also particularly effective in fuel oils having a final boiling point of less than 360° C.

The concentration of the fuel additive in the fuel oil may, for example, be in the range of 1 to 10,000 ppm of fuel additive (active ingredient) by weight per weight of fuel oil, for example, 10 to 5,000 ppm, such as 25 to 2,500 ppm (active ingredient) by weight per weight of fuel oil, preferably 50 to 1,500 ppm, more preferably 200 to 1,200 ppm.

Additive Concentrate

The fuel additive concentrate comprises the fuel additive defined above in admixture with a compatible solvent.

The fuel additive composition may take the form of a concentrate. Concentrates comprising the fuel additive in admixture with a carrier liquid (e.g. as a solution or a dispersion) are convenient as a means for incorporating the additive into bulk oil such as distillate fuel, which incorporation may be done by methods known in the art. The concentrates may also contain other additives as required and preferably contain from 3 to 90 wt %, more preferably 10 to 80 wt %, most preferably 20 to 75 wt % of the additives preferably in solution in oil. Examples of carrier liquids are organic solvents including hydrocarbon solvents, for example petroleum fractions such as naphtha, kerosene, diesel and heater oil; aromatic hydrocarbons such as aromatic fractions, e.g. those sold under the ‘SOLVESSO’ tradename; alcohols and/or esters; and paraffinic hydrocarbons such as hexane and pentane and isoparaffins. The carrier liquid must, of course, be selected having regard to its compatibility with the fuel additive and with the fuel oil.

The fuel additives of the invention may be incorporated into bulk oil by other methods such as those known in the art. If co-additives are required, they may be incorporated into the bulk oil at the same time as the additives of the invention or at a different time.

The invention will now be described, by way of example only, with reference to the following examples:

### EXAMPLE 1

### Differential Scanning Calorimetry (DSC) Method for Melting Point Determination

The DSC method measures the amount of heat (i.e. heat flow) needed to maintain a sample at the same temperature as a reference sample (i.e. an empty container) that is similarly cooled and heated.

The DSC test method involves heating a sample of wax (3-15 mg) in a small, sealed, aluminium container in a differential scanning calorimeter to a temperature above its melting point. The wax is then cooled at 5° C./min to a temperature well below its melting point. Finally the wax sample is then heated again at 5° C./min back to a temperature above its melting point.

A plot of temperature versus heat flow is prepared. Any phase changes, such as melting or freezing points, can be readily identified as more rapid changes in heat flow. Some waxes, depending on their composition, do not have sharp melting points so the end of melting can be difficult to pinpoint. In such cases, it is useful to draw a tangent from the steep part of the curve and to mark the point where it crosses the extended baseline, and denote this as the melting point.

### EXAMPLE 2

Various types of waxes (see Table 1) were tested in combination with typical co-additives to determine their efficacy as low temperature flow improvers as determined by the LTFT method. The results are shown in Table 3. The waxes were each made up into blend A (see formulation in Table 2 below). All of the components were blended together at 50° C. to produce a homogeneous solution.

TABLE 1

| | | | Melting | Refractive |
|---|---|---|---|---|
| | Wax | | Point (° C.) | Index |
| Wax ID | supplier | Trade Name | by DSC | at 70° C. |
| A1 | Honeywell | Microfiltrate | 23 | 1.4699 |
| A2 | Honeywell | Microfiltrate | 22 | 1.4714 |
| A3 | Honeywell | Microfiltrate | 24 | 1.4699 |
| B1 | Crompton | Witco Waxy Oil S-300 | 34 | 1.4611 |
| B2 | Crompton | Witco Waxy Oil S-300 | 35 | 1.4635 |
| B3 | Crompton | Witco Waxy Oil S-300 | 36 | 1.4622 |
| C | Crompton | Mineral Jelly #14 | 38 | 1.4472 |
| D | Mobil | Promor 103 | 77 | 1.4639 |
| E | Schumann- | ZLA 156/01 | 50 | 1.4546 |
| | Sasol | | | |
| F | Honeywell | Astorwax 3040 | 53 | 1.4518 |
| G | Crompton | Petrolatum 68 | 55 | 1.4628 |
| H | Crompton | Techpet F | 63 | 1.4698 |
| I | Exxon | Slackwax 150N | 56 | 1.4342 |
| J | Honeywell | Astorwax 130 Filtrate | 36 | 1.4403 |
| K | Crompton | Mineral Jelly #10 | 37 | 1.4454 |

TABLE 2
Blend A

| | | Component |
|---|---|---|
| Proportion | Component | Code |
| 10% | Polar nitrogen compound: the product of the | WASA |
| | reaction of 2 moles di-hydrogenated tallow | |
| | amine with 1 mole phthalic anhydride | |
| 20% | Growth arrestor: Ethylene-Vinyl Acetate | EVA |
| | copolymer, having an Mn of 3,500 and | |
| | containing 16 mole % vinyl acetate | |
| 60% | Test wax | Wax |
| 10% | Ethoxylated Sorbitan Tristearate | Nucleator |
| | (known as Tween 65) | |

TABLE 3

| | | | |
|---|---|---|---|
| | | | Lowest LTFT pass |
| | Melting Point | Refractive | (° C.) in Fuel A |
| Wax in | (° C.) | Index | treated with Blend A |

| Blend A | by DSC | at 70° C. | 800 ppm | 1050 ppm |
|---|---|---|---|---|
| No additive | | | −28 | −28 |
| A1 | 23 | 1.4699 | −35 | −38 |
| A2 | 22 | 1.4714 | | −36 |
| A3 | 24 | 1.4699 | | −38 |
| D1 | 34 | 1.4611 | −36 | −36 |
| B2 | 35 | 1.4635 | | −36 |
| C | 38 | 1.4472 | >−33 | |
| D | 77 | 1.4639 | −34 | |
| E | 50 | 1.4546 | >−34 | |
| F | 53 | 1.4518 | −33 | |
| G | 55 | 1.4628 | −34 | |
| H | 63 | 1.4698 | >−33 | |
| I | 56 | 1.4342 | >−33 | |
| J | 36 | 1.4403 | >−32 | |
| K | 37 | 1.4454 | >−32 | |

The results show that waxes, such as A1-3 and B1-2, which have a combination of low melting point and high refractive index, give the best results. Waxes having either low melting point or high refractive index alone do not give such good performance.

A further advantage of using waxes with low melting points is to improve the handleability of the additive concentrate. Poor handleability could severely limit the usage of the additive blend. Table 4 shows the pour point and appearance of Blend B using each of the waxes. Blend B comprises 75% of blend A and 25% of an aromatic solvent (Solvesso 150).

TABLE 4

| Wax | | | | Appearance of Blend B at | | |
|---|---|---|---|---|---|---|
| | Melting Point | Refractive | Blend B | test temperature after 1 week | | |
| ID | (° C.) by DSC | Index at 70° C. | Pour Point (° C.) | 20° C. | 40° C. | 50° C. |
| A1 | 23 | 1.4699 | 9 | Hazy fluid | clear fluid, <5% | clear fluid |
| | | | | | settled | |
| A2 | 22 | 1.4714 | 9 | Hazy fluid | clear fluid | clear fluid |
| B1 | 34 | 1.4611 | 15 | clear fluid | clear fluid | clear fluid |
| C | 38 | 1.4472 | 30 | gel | clear fluid | clear fluid |
| D | 77 | 1.4639 | >50 | gel | gel | gel |
| E | 50 | 1.4546 | 38 | gel | gel | fluid |
| F | 53 | 1.4518 | 42 | gel | gel | fluid, 40% |
| | | | | | | settled |
| G | 55 | 1.4628 | 42 | gel | semi-gel | clear fluid |
| H | 63 | 1.4698 | >40 | gel | semi-gel | clear fluid |
| I | 58 | 1.4354 | 45 | gel | gel | fluid |
| J | 36 | 1.4403 | 15 | 50% settled | clear fluid | clear fluid |
| K | 37 | 1.4454 | 24 | gel | clear fluid, 10% | clear fluid |
| | | | | | settled | |

It can be seen that the waxes that have low melting points give additive blends that have low pour points and are fluid at ambient temperature.

Waxes having melting points above 36° C. produce additive blends that are gelled at ambient temperature.

Most commercial waxes have melting points above 40° C. produce additive blends that are gelled even at 40° C.

### EXAMPLE 3

Other PEG ester blends were compared for their LTFT performance in fuel A. The results are shown in Table 5. The components used in the different are shown in Table 6.

TABLE 5

| Treat Rate (ppm ai) | | | | | | | | |
|---|---|---|---|---|---|---|---|---|
| | | | Wax | Nucleator | | | | |
| WASA | APFC | EVA | A1 | PEGS | Tween 65 | PEGB | Total | LTFTs at −35° C. |
| | | | | | | | No additive | Fail |
| 50 | 50 | 200 | 600 | 100 | | | 1000 | Pass |
| 50 | 50 | 200 | 600 | | 100 | | 1000 | Pass |
| 63 | 63 | 333 | 438 | 104 | | | 1000 | Pass |
| 63 | 63 | 333 | 438 | | 104 | | 1000 | Pass |
| 57 | 57 | 343 | 429 | | | 114 | 1000 | Pass |

The similar packages show that alternatives in the PEG ester family are also effective nucleators.

TABLE 6

| Component | Code |
|---|---|
| Polar nitrogen compound: the product of the reaction of | WASA |
| 2 moles di-hydrogenated tallow amine with | |
| 1 mole phthalic anhydride | |
| Growth arrestor: Ethylene-Vinyl Acetate copolymer, | EVA |
| having an Mn of 3,500 and containing | |
| 16 mole % vinyl acetate | |
| Test wax (A1 - microfiltrate) | Wax |
| Ethoxylated Sorbitan Tristearate | Tween 65 |
| Alkyl Phenol Formaldehyde Condensate | APFC |
| Other Nucleators: | |
| PEG 400 Distearate | PEGS |
| PEG 400 Dibehenate | PEGB |

### EXAMPLE 4

Additive Blend A, containing Wax A1 (the microfiltrate), was also tested in other fuels and compared to existing, commercial LTFT additives. The results are shown in Table 7.

TABLE 7

| Fuel | | Treat Rate | Lowest LTFT | |
|---|---|---|---|---|
| Description | Additive | (ppm ai) | Pass (° C.) | Comments |
| Canada 1 | None | 0 | −31 | |
| Canada 1 | Blend A | 700 | −35 | |
| | using wax | | | |
| | A1 | | | |
| Canada 1 | Blend A | 875 | −38 | Additive of the invention at |
| | using | | | 875 ppm enables half of the |
| | Wax A1 | | | kerosene in Canada 2 to be |
| | | | | diverted to other uses |
| Canada 1 | R541 | 800 | −32 | Other, commercial LTFT additives |
| Canada 1 | R533 | 900 | −32 | are not effective in this type of fuel |
| Canada 2 | None | 0 | −37 | Shows that fuel Canada 1 requires |
| | | | | an equal volume of kerosene for a |
| | | | | −37° C. LTFT, without additive |
| Canada 3 | None | 0 | −31 | |
| Canada 3 | Blend A | 700 | −36 | |
| | using wax | | | |
| | A1 | | | |
| Canada 3 | Blend A | 860 | −37 | |
| | using | | | |
| | wax A1 | | | |
| Canada 3 | R541 | 1350 | Fail −36 | Other, commercial LTFT additives |
| Canada 3 | R533 | 1040 | Fail −36 | are not effective in this type of fuel |

The target LTFT for these fuels was a pass at −36° C. or lower. Existing commercial LTFT additives are not effective in these fuels.

R541 is a blend of EVA (a combination of EVA nucleator and EVA arrestor) with the WASA (see Table 6).

R533 is a blend of EVA, a hydrogenated polybutadiene MDFI and WASA (see Table 6).

R541 and R533 contain neither an ethoxylate di-ester nor a wax.

Canada 2 is a blend of Canada 1 and kerosene in a ratio of 46:54.

Canada 3 is from a different refinery than Canada 1.

The characteristics of the fuels used in the examples are given below in Table 8.

TABLE 8

| Refinery | Test Fuel A | Canada 1 | Canada 2 | Canada 3 |
|---|---|---|---|---|
| Flash Point ° C. | 48 | | | 60 |
| Wax at 10° C. | 1.3 | | | |
| below WAT m % | | | | |
| Sulphur m % | 0.0417 | | | 0.0248 |
| Density at 15° C. | 820.4 | | | 852.8 |
| kgm⁻³ | | | | |
| KV at 20° C. cSt | 2.278 | | | 3.744 |
| D86 IBP | 151 | 152 | 152 | 170 |
| 5.0% | 169 | 167 | 165 | 191 |
| 10.0% | 179 | 174 | 171 | 199 |
| 20.0% | 189 | 186 | 179 | 213 |
| 30.0% | 200 | 200 | 189 | 226 |
| 40.0% | 213 | 215 | 200 | 241 |
| 50.0% | 225 | 233 | 213 | 256 |
| 60.0% | 237 | 248 | 226 | 271 |
| 70.0% | 250 | 263 | 239 | 287 |
| 80.0% | 263 | 281 | 253 | 304 |
| 90.0% | 283 | 305 | 276 | 325 |
| 95.0% | 299 | 323 | 302 | 339 |
| FBP | 317 | 335 | 323 | 349 |
| 90%-20% | 94 | 119 | 97 | 112 |
| FBP-90% | 34 | 30 | 47 | 24 |
| Cloud Point (° C.) | −30 | | | −33 |
| Pour Point (° C.) | | −42 | | −45 |
| Lowest LTFT pass | | −31 | −37 | |
| (° C.) | | | | |
| Simulated Filter | | −31 | −46 | |
| Plugging Point | | | | |
| (IP419/96) | | | | |
| (Also see | | | | |
| EP 0 403 097A2) | | | | |

What is claimed is:

1. A fuel additive comprising a) at least one wax having a refractive index of greater than 1.4550 at 70° C. and a melting point of less than 40° C.; and at least one of the following:
b) at least one growth arrestor;
c) at least one polar nitrogen compound;
d) at least one nucleator;
e) at least one comb polymer; and
f) at least one alkyl phenol formaldehyde condensate.

2. The fuel additive claimed in claim 1, comprising:
a) at least one wax having a refractive index of greater than 1.4550 at 70° C. and a melting point of less than 40° C.;
b) at least one growth arrestor;
c) at least one polar nitrogen compound; and
d) at least one nucleator.

3. The fuel additive of claim 1, wherein the wax has a refractive index of greater than 1.4600

4. The fuel additive of claim 1, wherein the wax has a refractive index of less than 1.4750.

5. The fuel additive of claim 1, wherein the wax has a melting point of between 10 to 40° C., preferably between 20 and 35° C.

6. The fuel additive of claim 1, wherein the growth arrestor is a copolymer of ethylene and one or more unsaturated esters, preferably selected from: ethylene-vinyl acetate, ethylene-vinyl propionate, ethylene-vinyl 2-ethylhexanoate, ethylene-vinyl 2-ethylhexanoate-vinyl acetate and ethylene-2-ethylhexylacrylate.

7. The fuel additive of claim 1, wherein the growth arrestor is a copolymer of ethylene and a 1-alkene having 3 to 8 carbon atoms, or a hydrogenated polybutadiene.

8. The fuel additive of claim 1, wherein the polar nitrogen compound carries one or more amino substituents selected from: mono- or di-dodecylamino, mono- or di-tetradecylamino, mono- or di-cocoamino and mono- or di-hydrogenated tallow amine.

9. The fuel additive of claim 1, wherein the nucleator is a polyoxyalkylene compound, preferably a polyoxyalkylene ester, ether, ester/ether or mixture thereof.

10. The fuel additive claimed in claim 9, wherein the nucleator is a stearic or behenic ester of polyethylene glycol, polypropylene glycol or polyethylene/propylene glycol mixture, or ethoxylated polyol.

11. The fuel additive of claim 1, wherein the nucleator is an ethoxylated ester of stearic or behenic acid and a polyol, preferably a polyol having 3 to 8 hydroxy groups.

12. A fuel oil composition comprising the fuel additive of claim 1 and a fuel oil.

13. The fuel oil composition as claimed in claim 12, wherein the fuel oil has a cloud point of less than or equal to −15° C., preferably less than or equal to −20° C., and even more preferably less than or equal to −25° C.

14. A method for reducing the low temperature operability of a fuel oil, the method comprising adding the fuel additive of claim 1 to the fuel oil.

15. The method claimed in claim 14, wherein the fuel oil has a cloud point of less than or equal to −15° C., preferably less than or equal to −20° C, and even more preferably less than or equal to −25° C.

16. A fuel additive concentrate comprising the fuel additive of claim 1 in admixture with a compatible solvent.
